(19) United States
(12) Patent Application Publication
(10) Pub. No.: US 2009/0313316 A1
(43) Pub. Date: Dec. 17, 2009

(54) EMBEDDED COMPOSITE INDICATORS OF DOCUMENT STATUS

(75) Inventor: Richard Douglas Kemp, Atlantic City, NJ (US)

Correspondence Address: FROMMER LAWRENCE & HAUG, 745 FIFTH AVENUE- 10TH FL., NEW YORK, NY, 10151, US

(73) Assignee: Bloomberg Finance L.P.

(21) Appl. No.: 12/140,381

(22) Filed: Jun. 17, 2008

(51) Int. Cl. G06F 15/16; G06F 17/00

(52) U.S. Cl. 709/202; 715/273; 715/207

(57) ABSTRACT

A document, which may be referred to as a “citing document,” is displayed. The display may comprise the text of the citing document, which may comprise one or more citations to one or more other documents. As displayed, one or more of the citations is associated with indicia of a value associated with the respective cited document. For example, a display of a judicial opinion may include citations to one or more other opinions, and one or more of the citations may be preceded by icons reflecting an estimate of the precedential value of each respective cited opinion. Computerized systems and methods for causing such display are also provided.

### CROSS-REFERENCE TO RELATED APPLICATIONS

This application is related to pending U.S. patent application Ser. No. 11/947,410, filed Nov. 29, 2007, and titled “Creation and Maintenance of a Synopsis of a Body of Knowledge Using Normalized Terminology,” which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyrights whatsoever.

### BACKGROUND

Written works often assert various facts and cite authorities to support those assertions. For example, in common-law jurisdictions, legal documents often cite case law, in the form of judicial opinions, to support legal arguments.

The strength of a cited authority may vary, however. Again referring to legal documents, legal authority may be overruled, criticized, or rendered less significant over time. Conversely, a decision may be widely cited and followed and may consequently take on greater importance.

The strength of a document as authority may not be apparent from the face of the document. Further, citing documents may not be edited to reflect changes in the strength of the authorities they cite, and even when such editing occurs, e.g., when publishing a new edition of a secondary source such as a treatise, substantial time may elapse between a change and the revision of the citing document. Although the current validity of cited authority may be determined, e.g., through reference to citation indexes, looking up such information can be inconvenient and distracting.

### BRIEF SUMMARY OF THE INVENTION

The invention relates to facilitating the determination of the strength of authority cited in documents. Specifically, according to embodiments of the invention, documents' references to one another are characterized based on their relative favorability or unfavorability. Some or all of such characterizations of a given document are then used to create a composite status for that document. When a document containing references to other documents is displayed, indicia of the composite status of the referred-to documents are embedded in the display in visual association with the respective references.

For example, in one embodiment related to legal documents (including but not limited to judicial opinions), citations to an opinion are evaluated based on their likely effect on the precedential value of the cited opinion. The evaluations are recorded and used to calculate a composite status, which may reflect the expected strength of each cited opinion as legal authority. Then, when a document is displayed, and the document contains one or more citations to judicial opinions, some or all of the citations are preceded by icons that indicate the estimated precedential values of the respective cited opinions.

According to an embodiment of the invention, a display is provided of a document that includes text and one or more citations, with each citation referring to a document. The display includes the text, which in turn includes textual citations and one or more embedded status indicators. Each status indicator is visually associated with a citation, for example, by immediately preceding it, and indicates the value of the cited document.

According to an embodiment of the invention, each status indicator is an icon. As above, each icon is associated with a citation that refers to a document, and some or all of the icons may be hyperlinks to entries in a citation index for the respective cited documents.

In an embodiment of the invention, the citing document and one or more of the cited documents are judicial opinions. In such an embodiment, the “value” of the cited document may be an estimate of its precedential value. In one embodiment of the invention, this estimate may be determined algorithmically, e.g., based on entries in a citation index that refers to the cited document.

In another embodiment of the invention, the “value” of the cited document may be a characterization of how the citing document treats the cited document.

Embodiments of the invention include methods of presenting displays such as those described above. According to an embodiment of the invention, such a method may include rendering the document in HTML and transmitting the rendered document to a user agent, such as a Web browser. Transmitting the rendered document to a user agent may comprise transmitting the rendered document via a data network, such as the Internet.

Embodiments of the invention also include systems, e.g., for providing displays and/or carrying out the methods described above. Such a system may comprise a programmable processor, an input device that provides input to the system, a database, and a memory. The memory may store instructions that, when carried out by the processor, cause the system to carry out a method such as described above.

### BRIEF DESCRIPTION OF THE DRAWINGS

The invention is illustrated in the figures of the accompanying drawings, which are meant to be exemplary and not limiting, and in which like references are intended to refer to like or corresponding things.

FIG. 1 illustrates a presentation of the contents and layout of one kind of citator according to the prior art.

FIG. 2 is a block diagram of a programmable digital computer according to the prior art.

FIG. 3 is a block diagram depicting internetworked computer systems according to the prior art.

FIG. 4 depicts a display of direct history within an electronic citator such as may be provided in connection with an embodiment of the invention.

FIG. 5 depicts a display of indirect history within an electronic citator such as may be provided in connection with an embodiment of the invention.

FIG. 6 depicts a display of an item of indirect history from the display depicted in FIG. 5.

FIG. 7 depicts an alternate display of indirect history within an electronic citator such as may be provided in connection with an embodiment of the invention.

FIG. 8 depicts a process flow for evaluating a document to produce a composite status according to an embodiment of the invention.

FIGS. 9 and 10 depict presentations of document text with embedded status indicators according to an embodiment of the invention.

FIG. 11 depicts a fragment of a document represented with XML markup according to an embodiment of the invention.

FIG. 12 depicts a process flow for rendering a document according to an embodiment of the invention.

### DETAILED DESCRIPTION OF THE PREFERRED EMBODIMENTS

Embodiments of the invention provide systems and methods for indicating how favorably or unfavorably respective documents in a collection refer to one another. The invention is illustrated herein through discussion of embodiments related to legal information, and especially to embodiments that indicate the continued precedential strength of case law. Such illustration is exemplary, however, and not limiting.

A judicial opinion may appear on its face to be mandatory or persuasive authority for a particular legal principle. But the effect of the decision represented by the opinion may be diminished, or even negated entirely, by subsequent decisions. Conversely, a particular opinion may be judged to have special import if it is widely and favorably cited.

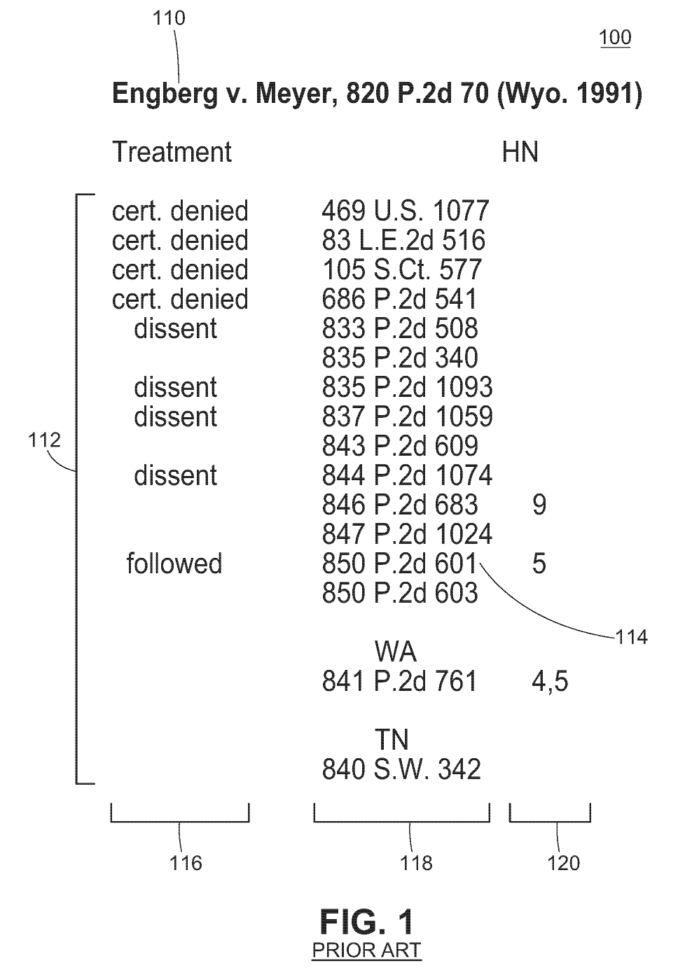

Lawyers may use a citation index (which may be referred to as a “citator”) to find documents that cite a particular authority, such as an opinion. FIG. 1 depicts an entry 100 in a representation of a citator according to the prior art. The entry comprises a caption 110, which in the depicted citator is in the form of a citation to the indexed opinion. As depicted, beneath the caption is a list 112 of opinions and/or other documents that cite the indexed opinion.

The list 112 comprises one or more items 114, each of which includes information in up to three columns. For any entry, the leftmost column 116 may hold a description of how the citing document treated the indexed opinion. Possible treatments resulting from further proceedings in the same or related cases (sometimes called the “direct history”) include, for example, denial of discretionary review, affirmance, and reversal by an appellate court. Possible treatments in other, independent cases (sometimes called the “indirect history”) include, for example, following the reasoning or rule of the indexed opinion, discussing the indexed opinion, criticizing it, declining to follow it, and overruling the previous decision. Some items in the list 112 may lack treatment information.

The center column 118 holds an abbreviated citation to the citing document.

Published judicial opinions in the United States commonly begin with one or more numbered “headnotes,” each headnote restating a significant principle from the opinion that it annotates. Thus, the rightmost column 120 may include one or more headnote numbers, which indicate the principle or principles for which the citing document referred to the indexed opinion. One or more list items 112 may have multiple headnote numbers, and one or more of them may have no headnote numbers at all.

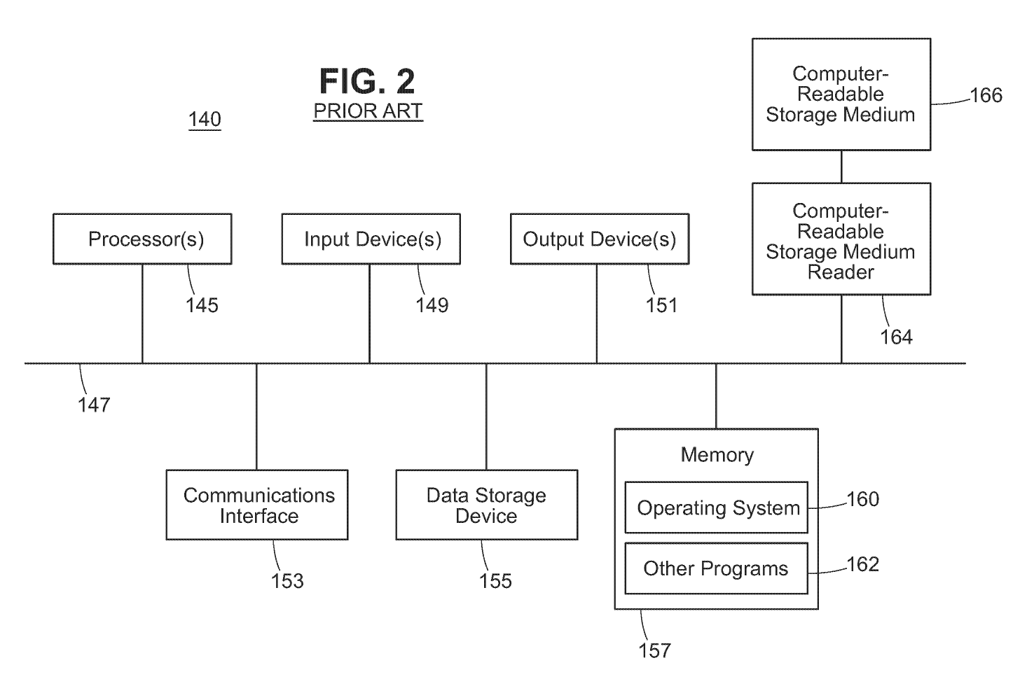

Like some other reference works, a citation index such as a citator can be provided and enhanced, e.g., through the use of electronic data processing systems, such as those comprising one or more programmable digital computers. (A citation index so provided may be referred to herein as an “electronic citator.”) FIG. 2 is a block diagram of a representative prior art computer system.

As depicted in FIG. 2, the computer system 140 includes at least one processor 145, such as an Intel® Core™ 2 microprocessor or a Freescale™ PowerPC® microprocessor, coupled to a communications channel 147. The computer system 140 further includes an input device 149 such as, e.g., a keyboard or mouse, an output device 151 such as, e.g., a CRT or LCD display, a communications interface 153, a data storage device 155 such as a magnetic disk or an optical disk, and memory 157 such as Random-Access Memory (RAM), each coupled to the communications channel 147. The communications interface 153 may be coupled to a network such as the Internet.

One skilled in the art will recognize that, although the data storage device 155 and memory 157 are depicted as different units, the data storage device 155 and memory 157 can be parts of the same unit or units, and that the functions of one can be shared in whole or in part by the other, e.g., as RAM disks, virtual memory, etc. It will also be appreciated that any particular computer may have multiple components of a given type, e.g., processors 145, input devices 149, communications interfaces 153, etc.

The data storage device 155 and/or memory 157 may store an operating system 160 such as Microsoft Windows XP® or Windows Vista™, Linux®, Mac OS®, or Unix®. Other programs 162 may be stored instead of or in addition to the operating system. It will be appreciated that a computer system may also be implemented on platforms and operating systems other than those mentioned. Any operating system 160 or other program 162, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

One skilled in the art will recognize that the computer system 140 may also include additional components and/or systems, such as network connections, additional memory, additional processors, network interfaces, input/output busses, for example. One skilled in the art will also recognize that the programs and data may be received by and stored in the system in alternative ways. For example, a computer-readable storage medium (CRSM) reader 164, such as, e.g., a magnetic disk drive, magneto-optical drive, optical disk drive, or flash drive, may be coupled to the communications bus 147 for reading from a computer-readable storage medium (CRSM) 166 such as, e.g., a magnetic disk, a magneto-optical disk, an optical disk, or flash RAM. Accordingly, the computer system 140 may receive programs and/or data via the CRSM reader 164. Further, it will be appreciated that the term “memory” herein is intended to include various types of suitable data storage media, whether permanent or temporary, including among other things the data storage device 155, the memory 157, and the CSRM 166.

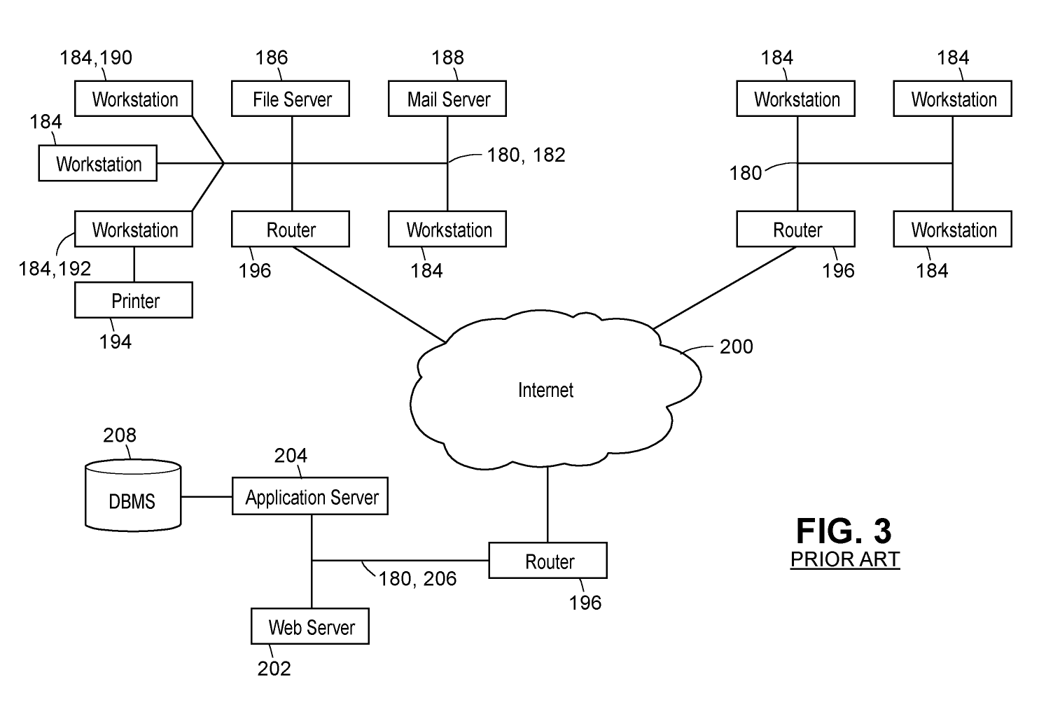

Two or more computer systems 140 may be connected, e.g., in one or more networks, via, e.g., their respective communications interfaces 155 and/or network interfaces (not depicted). FIG. 3 is a block diagram of representative prior art interconnected networks 180, such as may be useful in connection with embodiments of the invention.

A network 182 may, for example, connect one or more workstations 184 with each other and with other computer systems, such as file servers 186 or mail servers 188. The connection may be achieved tangibly, e.g., via Ethernet® or optical cables, or wirelessly, e.g., through use of modulated microwave signals according to the IEEE 802.11 family of standards. A computer system that participates in the network may send data to another computer system in the network via the network connection.

One use of a network 180 is to enable a computer system to provide services to other computer systems, consume services provided by other computer systems, or both. For example, a file server 186 may provide common storage of files for one or more of the workstations 190 on a network 182. A workstation 190 sends data including a request for a file to the file server 186 via the network 182 and the file server 186 may respond by sending the data from the file back to the requesting workstation 190.

As will be recognized by those skilled in the relevant art, the terms “workstation,” “client,” and “server” are used herein to describe a computer in terms of its function in a particular context. A workstation may, for example, be a computer that one or more users work with directly, e.g., through a keyboard and monitor directly coupled to the computer system. A computer system that requests a service through a network is often referred to as a client, and a computer system that provides a service is often referred to as a server. But any particular workstation may be indistinguishable in its hardware, configuration, operating system, and/or other software from a client, server, or both.

Further, a computer system may simultaneously act as a workstation, a server, and/or a client. For example, as depicted in FIG. 3, a workstation 192 is connected to a printer 194. That workstation 192 may allow users of other workstations on the network 182 to use the printer 194, thereby acting as a print server. At the same time, however, a user may be working at the workstation 192 on a document that is stored on the file server 186.

A network 182 may be connected to one or more other networks 180, e.g., via a router 196. A router 196 may also act as a firewall, monitoring and/or restricting the flow of data to and/or from a network 180 as configured to protect the network. A firewall may alternatively be a separate device (not pictured) from the router 196

A network of networks 180 may be referred to as an internet. The term “the Internet” 200 refers to the worldwide network of interconnected, packet-switched data networks that uses the Internet Protocol (IP) to route and transfer data. A client and server on different networks may communicate via the Internet 200. For example, a workstation 190 may request a World Wide Web document from a Web Server 202. The Web Server 202 may process the request and pass it to, e.g., an Application Server 204. The Application Server 204 may then conduct further processing, which may include, for example, sending data to and/or receiving data from one or more other data sources. Such a data source may include, e.g., other servers on the same network 206 or a different one and/or a Database Management System (“DBMS”) 208.

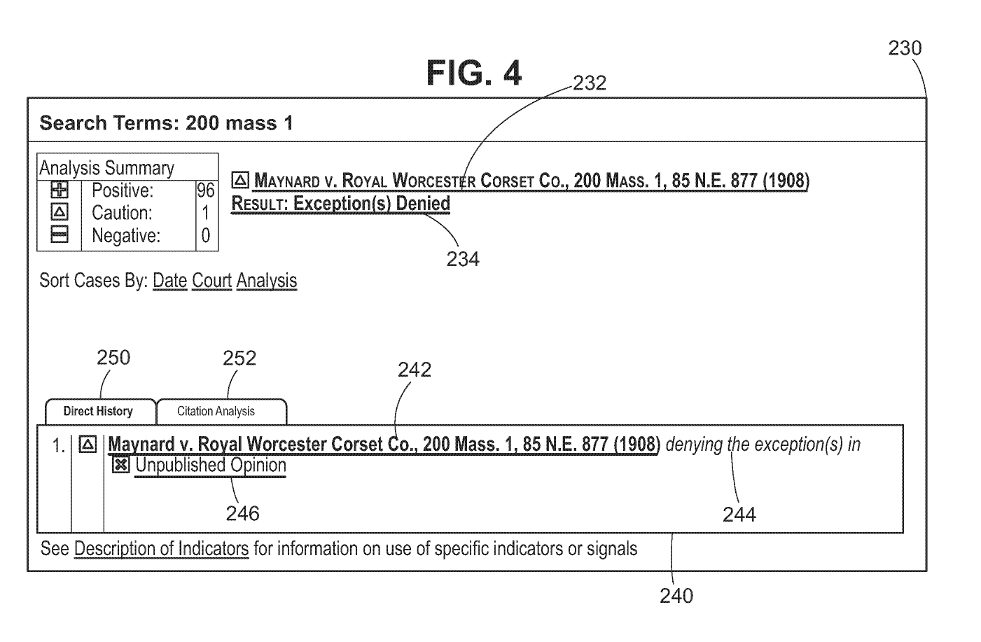

An electronic citator, such as may be provided in connection with an embodiment of the invention, may present information, e.g., as depicted in the display 230 in FIG. 4. The display comprises a citation 232 to the 1908 opinion (the “indexed opinion”) of the Supreme Judicial Court of Massachusetts in the matter of Maynard v. Royal Westchester Corset Co., in one form that is commonly used to identify legal opinions. The display 230 also comprises a summary 234 of the decision of the court that issued the indexed opinion.

The display 230 comprises an area 240 for presentation of the direct history. Within this area 240, a citation 242 to the indexed opinion may be presented along with one or more citations to other decisions in the case, thereby showing the context in which the opinion issued. One or more entries in the direct history may comprise an explanatory phrase that indicates the relationship between the associated entry and one or more other entries in the direct history.

Some decisions and opinions are unreported or otherwise unavailable. When an entry refers to such an unavailable resource, a placeholder 246 (e.g., “Unpublished Opinion”) may indicate that a relationship involves such a resource.

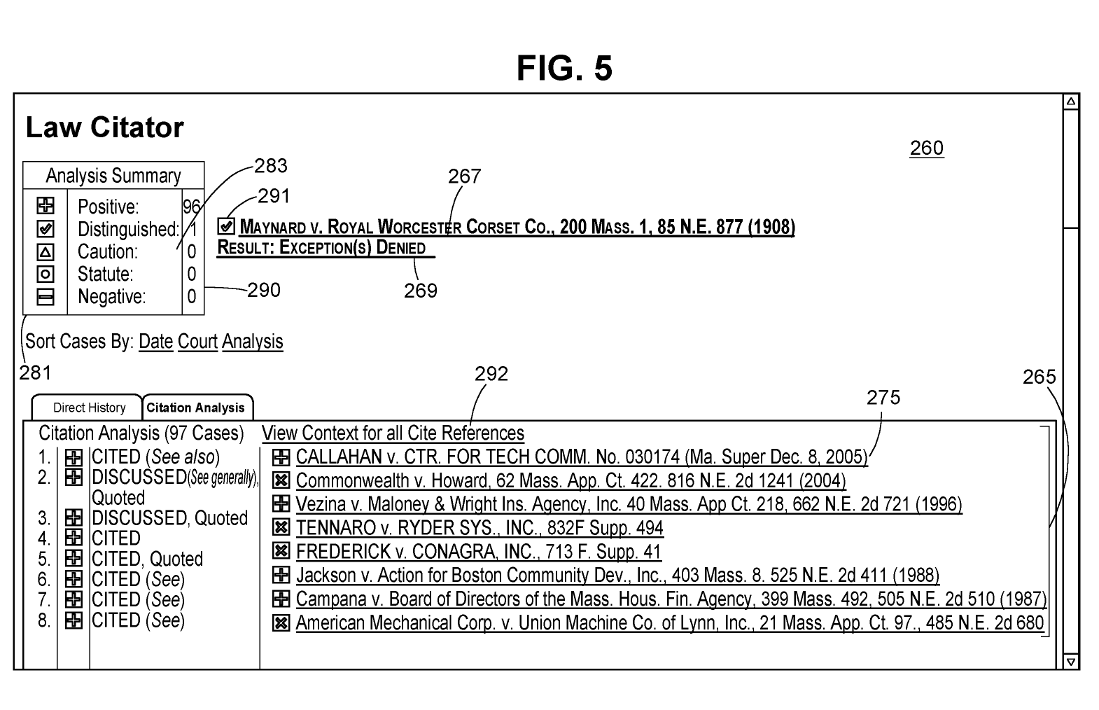

The display 230 includes tabs to indicate the availability of multiple kinds of information. The tab 250 labeled “Direct History” includes text in boldface, which indicates that the direct history of the indexed opinion is currently displayed. The other tab 252, labeled “Citation Analysis,” is a hyperlink to a display 260 of indirect history, such as FIG. 5 depicts.

The citator depicted in FIG. 5 comprises a list 265 of documents that cite the indexed opinion. A citation 267 to this opinion appears at the top of the display 260 in one form that is commonly used to identify judicial opinions. As depicted, the citation 267 is a hyperlink to the text of the indexed opinion (not depicted). This example also includes a brief statement 269 of the result that the court reached in the indexed opinion, presented just below the citation 267.

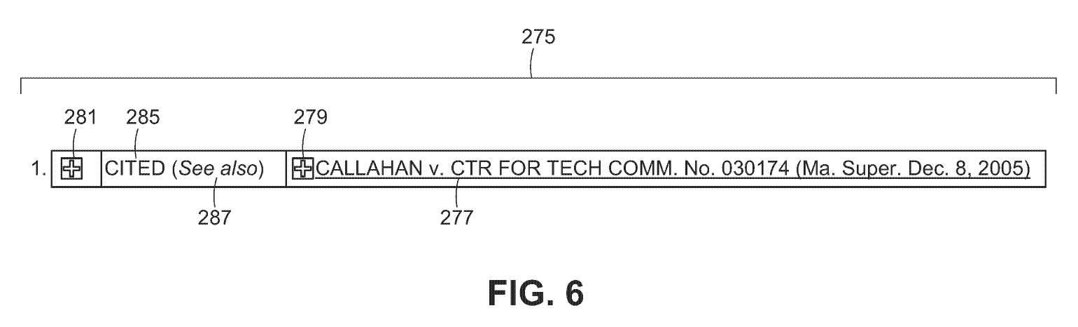

As depicted in FIG. 5, the citator presents a list 265 of all opinions (the “citing opinions”) that are known to have cited the indexed opinion, and FIG. 6 depicts a single entry 275 from that list. The entry 275 includes a citation 277 to the citing case in one form commonly used to identify judicial opinions. As depicted, the citation 277 is a hyperlink to the text of the citing opinion (not depicted). Adjacent to the citation 277 is a symbol 279 (e.g., “+” or “×”) that may indicate the continued significance of the citing opinion in view of subsequent events. An alternative implementation of a citator may omit such an indication entirely or provide other indicia (e.g., annotation with one or more characters or words, color-coding, highlighting, and/or selection of a typeface and/or one or more attributes thereof for some or all of the entry) of the significance of a citing opinion in addition to or instead of one or more symbols as depicted in FIGS. 5 and 6.

A citator, such as may be provided in connection with an embodiment of the invention, may record the nature of a citing opinion's reference to a cited opinion (which may be referred as the “treatment” of the cited opinion). For example, a treatment may receive one or more characterizations, such as “cited,” “discussed,” “followed,” “distinguished,” “criticized,” “superseded by statute,” “overruled in part,” “overruled,” or “unknown.” The treatment or treatments may then be recorded, e.g., for use with a citator.

According to an embodiment of a citator, positive treatments may include, for example, a treatment of “cited,” which means that an opinion has been positively cited for a particular proposition. A treatment of “discussed” means that the citing opinion, in addition to citing the opinion favorably, gives additional details about the cited opinion.. A treatment of “followed” indicates that the citing opinion regards the cited opinion as controlling or persuasive authority.

As for negative treatments, a treatment of “distinguished” means that the citing opinion differentiates the cited opinion on the basis of the facts of the two cases. A treatment of “criticized” means that the citing opinion criticizes the cited opinion. A treatment of “superseded by statute” means that a proposition relied upon in the cited opinion has been impacted, overruled, or superseded by a statute. And a treatment of “overruled” may mean that the citing opinion arrives at a contrary legal analysis to that reached in the cited opinion. (A decision may in a particular case be overruled only in part, and a citator may recognize this.)

A citator may record a treatment of “unknown,” e.g., when the citing document is under review.

In connection with an embodiment of the invention, a citator may support the recording of only some of the treatments described above. An alternative citator may support one or more other treatments in addition to or instead of some or all of the described treatments. Additionally, a citator may associate one or more of the terms described above with a treatment or treatments other than as described above.

In an embodiment of the invention, a citation index may include one or more other treatments instead of or in addition to one or more of the treatments discussed above, reflecting, e.g., differences in the types of documents and/or the fields of knowledge that they pertain to. A scientific paper, for example, may present an experimental result, which may subsequently be confirmed by other experiments, contradicted by them, or even retracted, e.g., because the authors found a flaw in their method. Treatments in connection with a scientific citation index may reflect, e.g., these possibilities and/or others.

As depicted in FIG. 6, an entry 275 includes a symbol 281 that indicates the citing opinion's treatment of the indexed opinion. The exemplary citator (FIG. 5) uses five symbols 281, and a key 283 to the meanings of the symbols is included in the display 260. For example, the plus sign (“+”) in a green square 281, depicted in FIG. 6, indicates positive treatment, e.g., that the citing opinion explicitly indicated approval of the indexed opinion or did so implicitly by accepting the authority or guidance of the indexed opinion.

As depicted in FIGS. 5 and 6, the citator does not display indicators that distinguish between all treatments discussed above. A citator such as the one depicted may associate one or more such treatments and/or other treatments with one or more displayed symbols. An alternative embodiment of a citator may use additional and/or other symbols and/or other indicia and may thereby indicate finer, coarser, and/or other distinctions between treatments of cited documents.

The depicted entry 275 also describes the form of the reference within the citing opinion. For example, the depicted entry includes the description “CITED (See also)” 285. An entry 275 in a citator may variously comprise descriptions that indicate, e.g., that a citing opinion also discussed the indexed opinion or quoted a portion of it. As depicted in FIG. 6, the description 285 also indicates that the citation in the citing opinion was introduced by the words “See also” 287 which may be considered an example of a “signal.”

Returning to FIG. 5, the display 260 includes a summary 290 of the citing opinions' treatment of the indexed opinion. The depicted example indicates that 97 opinions cited the indexed opinion. Of the citing opinions, as indicated in the analysis summary 290, 96 treated the indexed opinion positively, and 1 treated the indexed opinion in a way that suggests caution in relying on the indexed opinion.

According to an embodiment of the invention, some or all of the information presented in the analysis summary 290 can be used to calculate a composite status, which can be indicated, e.g., by a symbol 291, such as FIG. 5 depicts. The status may indicate, e.g., the likely precedential value of the indexed opinion in view of all indexed citations. In the depicted embodiment of the invention, the symbol 291 indicating the composite status is one of the symbols 281, presented with the key 283, which serve to indicate the individual citing opinions' treatment of the indexed opinion. In an embodiment of the invention, other symbols may be used instead of or in addition to some or all of the depicted symbols 281.

Alternatively, other indicia of status may be present instead of or in addition to symbols. Text highlighting, coloring, styling, or some combination thereof may be used in addition to or instead of symbols, according to an embodiment of the invention. One or more words, alphanumeric codes, or combination of the two may, in an embodiment of the invention, serve to indicate status in addition to or instead of some or all of the foregoing.

As depicted in FIG. 5, the entries are sorted by the dates of the citing opinions that they represent, with the most recently issued opinions listed first. Other sort keys may be used in an embodiment of the invention (not pictured) instead of or in addition to the date of the opinion, including, for example, one or more of the jurisdiction (e.g., federal court or one of the state courts), the court level (e.g., trial or appellate), and the opinion type (e.g., majority, per curiam, concurring, or dissenting), among other possibilities. Any one or more criteria, including for example any one or more of the preceding sort criteria, may also be used in an embodiment of the invention (not pictured) to break the list of citations into groups.

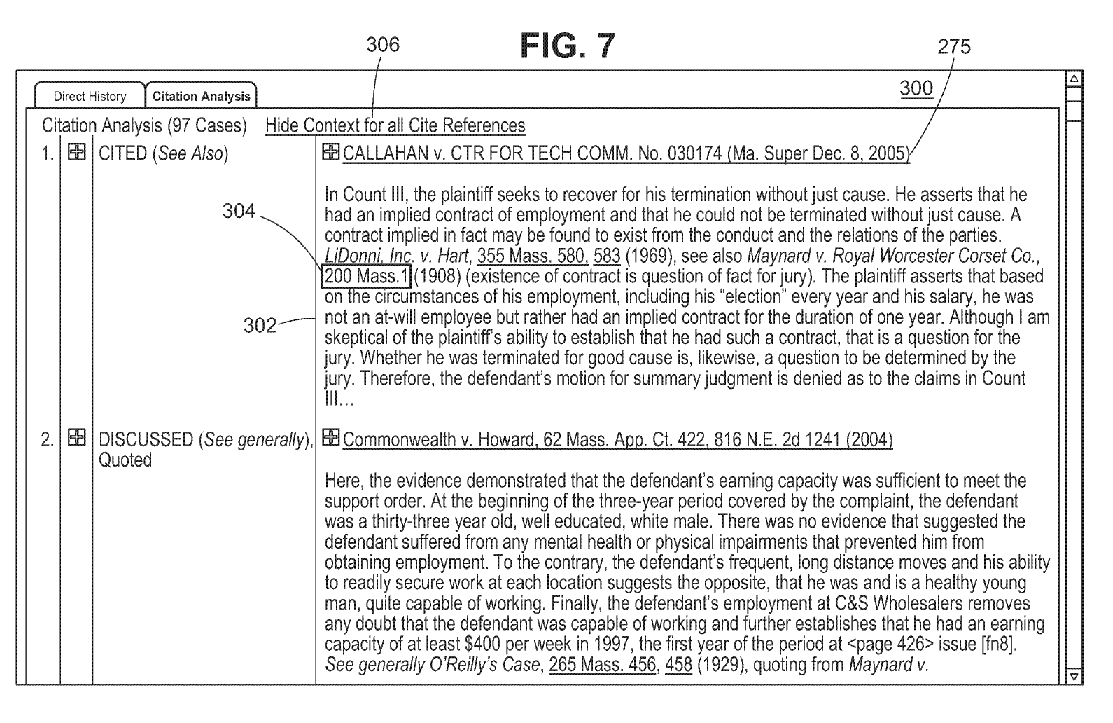

The display 260 (FIG. 5) includes a hyperlink 292 that leads to the modified display 300 depicted in FIG. 7. As depicted therein, each entry 275 in the citator is accompanied by an excerpt 302 from the citing opinion that includes the citation 304, providing context. A hyperlink 306 leads, e.g., back to the display 260 depicted in FIG. 5.

As depicted in FIGS. 5 and 7, either all citations are accompanied by excerpts, or none of them are. In an embodiment of the invention, one or more user interface components (not pictured) may be provided that allow excerpts to be displayed and/or hidden in connection with citations individually and/or in groups.

As discussed above, a citator may identify the aspect of the indexed opinion that the citing opinion refers to. For example, a citator may identify the page or pages of the indexed opinion that the citing opinion discusses. An alternative citator may refer to one or more points discussed in the indexed opinion, e.g., by including with the entry for each citing opinion an indication of the point or points discussed, such as a headnote number. In practice, these approaches can be expected to have similar results, and a particular citator may use either approach or a combination of the two.

Another way to indicate the principle for which a case has been cited is disclosed in the pending, commonly-owned U.S. patent application titled “Creation and Maintenance of a Synopsis of a Body of Knowledge Using Normalized Terminology,” Ser. No. 11/947,410, which was filed Nov. 29, 2007, and which has been incorporated herein by reference.

A citation index may record separate treatments for one or more points addressed in a cited document in addition to or instead of an overall treatment for a particular citing opinion. For example, an opinion disposing of a motion for summary judgment in a contract dispute may discuss both the legal standards applicable to summary judgment and one or more principles of contract law. That opinion may be cited for its discussions of one or more of these topics, and a citation index may record the topic or topics cited and treatment information for one or more such topics.

According to an embodiment of the invention, a composite status may be assigned to one or more cited opinions based on, e.g., the overall treatment or the treatment or treatments of one or more topics within the cited opinions. In an embodiment of the invention, a user may select the basis for the composites as indicated within document text, e.g., by following a hyperlink (not pictured) and/or by setting one or more preferences (not pictured). In an embodiment of the invention, the use of an overall composite or a topic-related composite may reflect the currently-viewed citing document's use of the cited document.

According to an embodiment of the invention, the composite status may be assigned or revised, e.g., by a human editor at the time the editor evaluates a citing opinion's treatment of the indexed opinion. In such an embodiment, the editor may first evaluate a citing opinion's treatment of the cited opinion. The editor may then consider or reconsider the continued precedential value of the cited opinion in view of the newly-evaluated citation.

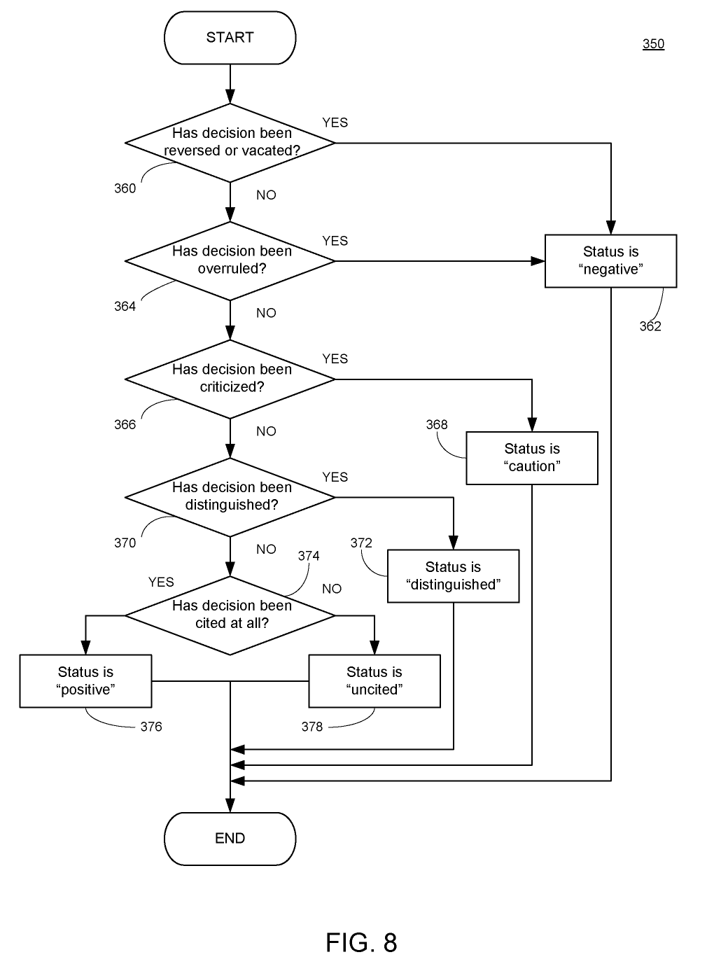

Alternatively, according to an embodiment of the invention, the composite status may be computed, e.g., based on the identified treatments of the indexed opinion in the citing opinions. FIG. 8 depicts one exemplary algorithm 350 that may compute the composite status according to an embodiment of the invention. The effect of the depicted algorithm is to give to an opinion a composite rating that matches the most negative treatment by any citing opinion.

Thus, in the embodiment depicted in FIG. 5, it is first determined in block 360 whether the cited opinion has been vacated or reversed on appeal. If so, the composite status is set to “negative” in block 362. If not, it is then determined in block 364 if the opinion has been overruled in a subsequent opinion. If so, as with vacated or reversed decisions, the opinion's status is set to “negative” in block 362.

If the decision has not been vacated, reversed, or overruled, as above, it is determined in block 366 whether any citing opinion has criticized the cited opinion. If so, the composite status is set to “caution” in block 368.

The precedential force of an opinion may be diminished if citing opinions commonly distinguish it on the basis of the underlying facts. It is well known in the art that such references can effectively diminish the applicable scope of the opinion. In extreme cases, the effect of such steady diminution can limit the application of the precedent to the unique set of facts at issue in the original case, and effectively overruling the ostensibly valid precedent.

For the foregoing reasons, if it is determined in block 370 that any citing opinion has distinguished the cited opinion on the facts, and the cited opinion has not otherwise received a composite status, the composite status is set to “distinguished” in block 372.

In an embodiment of the invention, if it has been determined after block 370 that no citing opinion has negatively treated the cited opinion, the cited opinion will receive a composite status of “positive.” In an alternative embodiment of the invention, as depicted in FIG. 5, it is determined in block 374 whether the opinion has in fact been cited at all. If so, because any negative treatment would have been detected in a previous step, the composite treatment is determined to be “positive” in block 376. Otherwise, the composite status is set to “uncited” in block 378.

Still another embodiment of the invention may combine automatic and manual techniques for assigning case status. For example, a proposed new composite status may be computed automatically (e.g., as FIG. 5 depicts) whenever a citing opinion's treatment of an indexed opinion is added or modified, but such a proposal would be reviewed by one or more human editors. The recorded composite status of the indexed opinion would not change until and unless the computed proposal received editorial approval.

The composite status and its presentation have so far been discussed only in connection with an electronic citator. But it will be appreciated that once a composite status has been calculated for an opinion, for use in connection with a citator, the information may be available for other uses.

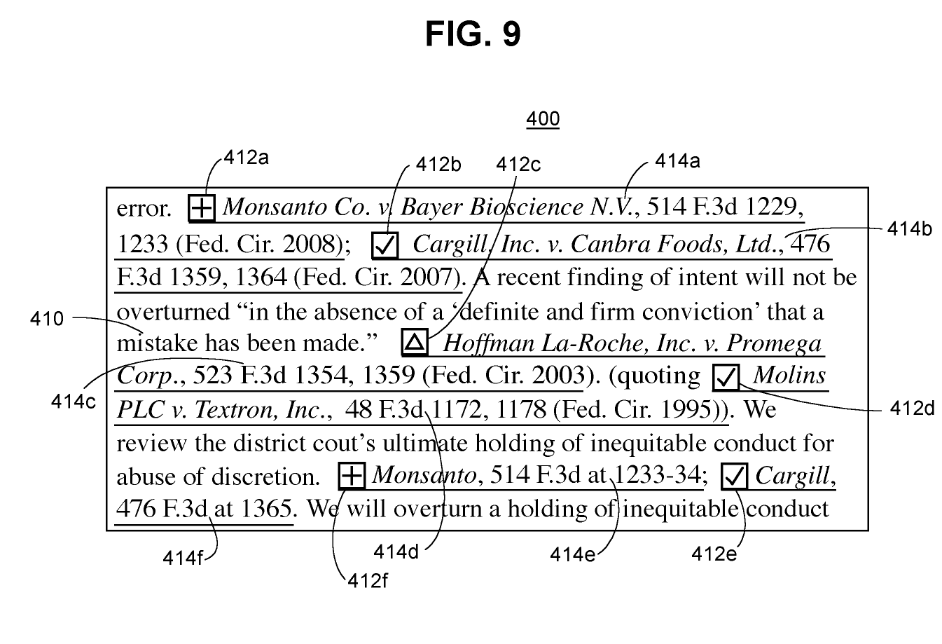

FIG. 9 illustrates one such use, depicting a display 400 of text 410 of a judicial opinion in which status indicators 412a-f are embedded, according to an embodiment of the invention. The depicted excerpt includes six citations 414a-f to other opinions. According to the depicted embodiment of the invention, each cited opinion has received a composite status, e.g., as discussed above in connection with FIG. 8. In the display 400 of the opinion text 410, each citation 414a-f is accordingly preceded by an icon 412a-f that indicates the composite status of the cited opinion.

For example, in FIG. 9, the first displayed citation in the text is a citation 414a to the opinion of the U.S. Court of Appeals for the Federal Circuit in Monsanto Co. v. Bayer Bioscience N. V. According to the depicted embodiment of the invention, at the time the display 400 was produced, no opinion was known to have cited Monsanto negatively. The Monsanto opinion consequently, according to an embodiment of the invention, has a composite status of “positive” or “cited.” In the display 400 of the text 410, the icon containing a plus sign (“+”) 412a indicates the composite status.

In the depicted embodiment of the invention, the same indicator is inserted into the text 410 for each citation to the same opinion. For example, the text 410 in the depicted display 400 includes a second citation 414e to Monsanto. As with the first citation 414a to this opinion, the second citation 414e is preceded by the icon 412e that indicates the positive composite status.

As depicted in FIG. 9, the second displayed citation 414b is to the opinion of the U.S. Court of Appeals for the Federal Circuit in Cargill, Inc. v. Canbra Foods, Ltd. As of the production of the depicted display 400, at least one court cited Cargill in an opinion that distinguished the facts before the citing court from the facts in Cargill. Cargill therefore has a composite status of “distinguished,” which, according to the depicted embodiment of the invention, is indicated by preceding the citation 414b to Cargill with a check-mark icon 412b.

In an embodiment of the invention, the embedded status indicators 412a-f reflect the composite status of the associated cited opinions as of the time the display 400 is presented. If a particular opinion is presented at a first time and then again, later, at a second time, the composite status of one or more cited cases may change in the interval. In an embodiment of the invention, the display 400 of the opinion would, reflecting such changes in status, embed different icons in the text 410 of the opinion at the different times.

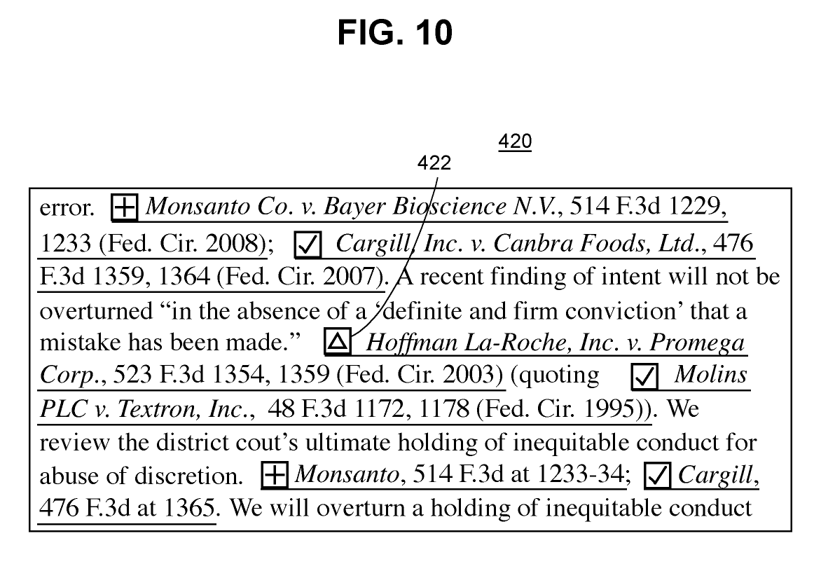

For example, the display 400 includes a citation 414c to the opinion of the Federal Circuit in Hoffman La-Roche, Inc. v. Promega Corp. The citation 414c is preceded by an icon 412c that indicates that the current composite status of the opinion is “distinguished.” If, after the presentation of the display 400, the citator records an opinion containing criticism of the opinion in Hoffman La-Roche, the composite status of Hoffman La-Roche may change to reflect the criticism. A subsequently-presented display 420 of the opinion text (FIG. 10), may then replace the status indicator 412c (FIG. 9) with an indicator 422 (FIG. 10) that reflects the changed status.

Displays such as FIGS. 9 and 10 depict may convey information other than that described above. For example, according to an embodiment of the invention, the embedded indicators 412a-f may reflect the currently-displayed opinion's treatment of each cited opinion, rather than indicating the composite status. It will be appreciated that the appearance of document text in connection with such an embodiment of the invention may not differ, or may differ only slightly, from the depictions of FIGS. 9 and 10, albeit the treatment indicia may have different meanings. In accordance with an embodiment of the invention, moreover, the significance of the symbols may be set, e.g., by a user, for example through use of a user preference item (not pictured) or a hyperlink or user interface control (not pictured).

The preceding examples concerned judicial opinions that cite other judicial opinions, but these examples are illustrative, not limiting, other documents may be treated similarly. According to an embodiment of the invention, a citing document, a cited document, or both, may be something other than a judicial opinion. For example, the U.S. Securities and Exchange Commission sometimes issues “no-action” letters in response to requests for clarification of the legality of certain activities, and such letters may cite statues and/or regulations. In an embodiment of the invention, the displayed text of such a letter may include embedded indicators of the continued applicability of cited statues and/or regulations and may thereby suggest, e.g., the continued reliability of the guidance contained in the no-action letter.

A citing or cited document may, in an embodiment of the invention, relate to field other than law. As discussed above, for example, a scientific paper may be cited for a particular result. In an embodiment of the invention, the indicators may suggest, e.g., the continued reliability of the result in view of later reported experiments.

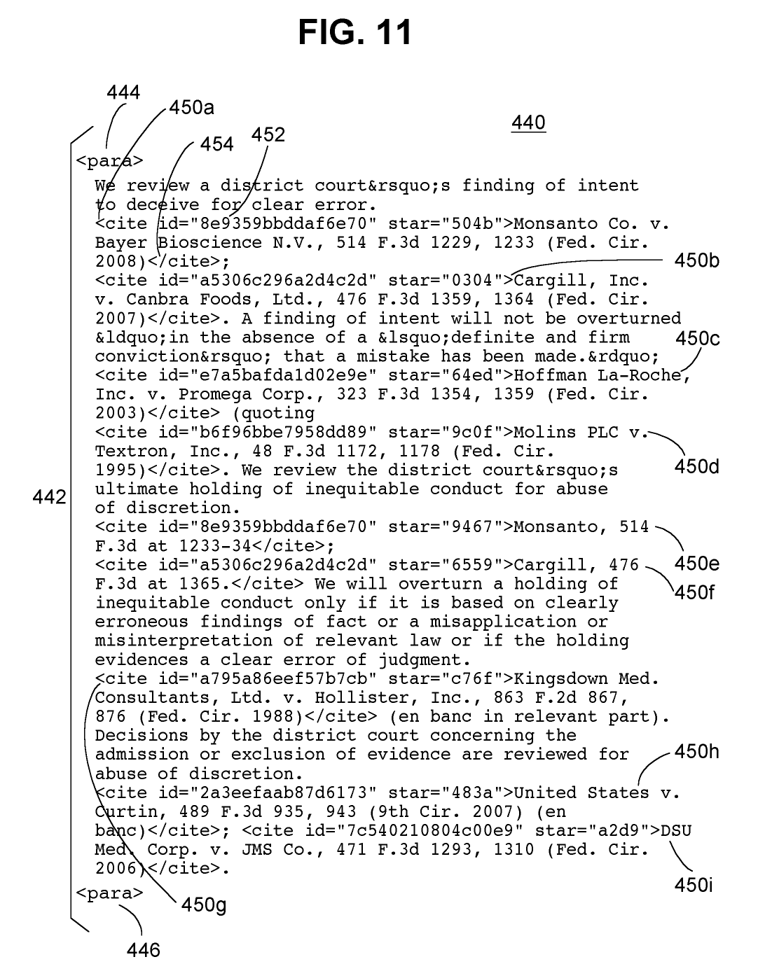

In an embodiment of the invention, data used to present an opinion with embedded status indicators, e.g., as FIGS. 9 and 10 illustrate, may be stored in a way so that the opinion text and the composite status are separate from one another. FIG. 11 depicts a fragment 440 of an opinion represented as a document that contains text marked up, e.g., in XML, as may be used to generate the displays of FIGS. 9 and 10. The fragment 440 includes the text of a single paragraph of the opinion, represented as a single XML element 442 that is delimited by “<para>” 444 and “</para>” 446 tags.

The paragraph element 442 includes text and multiple citation elements 450a-h, each delimited by “<cite>” 452 and “</cite>” 454 tags. The content of each citation element 450a-h is the text of the citation as it appears in the opinion. In the depicted embodiment of the invention, each citation element 450a-h has two attributes, represented in the depicted document by the “id” 456 and “star” 458 XML attributes of the “<cite>” tags 452.

According to an embodiment of the invention, the value of the “id” attribute is a code that uniquely identifies the cited document. In the embodiment depicted in FIG. 11, these codes are sixteen-digit hexadecimal numbers, but this is merely illustrative. It will be appreciated by one skilled in the relevant arts that many other methods are known for generating and representing unique codes and can be equally well suited for use in connection with embodiments of the invention.

In an alternative embodiment of the invention, the id code 456 does not just uniquely identify the cited document, but instead uniquely identifies the citation in the citing document. The citation refers to a particular document, and the id code 456 therefore uniquely, but indirectly, refers to the cited document. But as is well known in the relevant arts, a citation may include additional information, such as a reference (sometimes referred to as a “jump cite”) to a particularly relevant portion of the cited document or so-called “parallel citations” to the same opinion in multiple publications. Identifying the citation rather than the cited document may be used to associate this additional information with textual citations without embedding the information itself in the document.

In an embodiment of the invention such as FIG. 11 depicts, however, additional information is embedded in the XML representation of the opinion. The value of the “star” attribute 458 is a code indicating a location within the cited opinion corresponding to a jump cite, as discussed above.

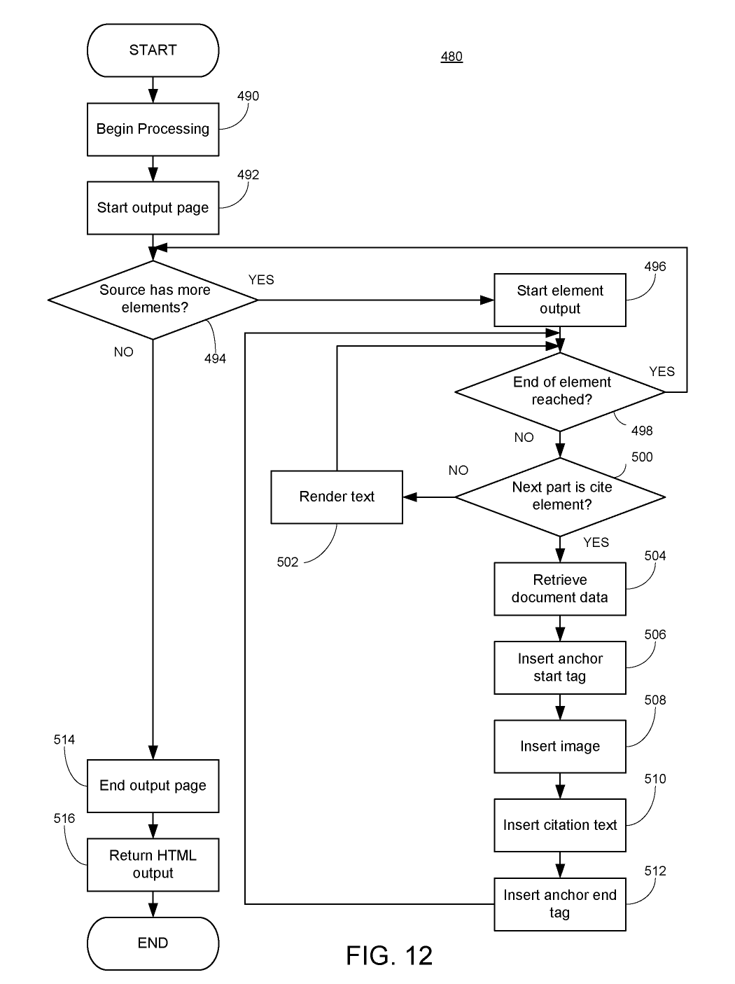

FIG. 12 depicts a process 480 for producing a representation of opinion text 410 (FIG. 9) from an XML source document 440 (FIG. 11) according to an embodiment of the invention. As discussed herein, the process 480 for producing the representation (sometimes referred to as “rendering” the document) involves producing a document marked up using HTML, which may then be sent across one or more computer networks to a user agent (e.g., a Web browser, such as Safari®, Firefox®, or Internet Explorer®), which may present the HTML document to a user in a human-readable form. The discussion is merely illustrative, however, and one skilled in the art will recognize that embodiments of the invention may comprise any transformation of a computer-readable representation of a document into a human-readable form that includes one or more perceptible status indicators.

As depicted in FIG. 12, the process 480 for rendering the opinion text begins in block 490, which may comprise, e.g., receiving a request for the opinion directly or indirectly from a user, an automatic processing system, or both. Block 492 includes initialization of an output HTML page, e.g., by outputting HTML header elements and an opening “<body>” tag, e.g., to a memory buffer or immediately via a network connection. Rendering 480 the text of the opinion in the body of the HTML document, according to the depicted process 480, then continues until it is determined in block 494 that all relevant portions of the XML source document 440 (FIG. 11) have been processed.

As is well known in the relevant art, a well-formed XML document comprises one or more hierarchical elements. Returning to FIG. 12, the process 480 of rendering the output text includes, in block 496, providing output corresponding to the beginning of the next element encountered in the XML source document 440 (FIG. 11). For an XML source document 440 structured as depicted in FIG. 11, in which the next element processed in block 496 (FIG. 12) represents a paragraph of opinion text, the output in block 496 may be, for example, an HTML “<p>” tag.

In an embodiment of the invention, until it is detected in block 498 that the current element has been fully processed, the contents of the current XML element may then be rendered, e.g., as HTML. In connection with an embodiment of the invention, the content of such a paragraph element may be, e.g., text, one or more subordinate elements, or both. If it is determined in block 500 that the next part of the XML content is not a citation element, the content is simply rendered in block 502, which may comprise copying the text content into the HTML output document.

(For the sake of simplicity, FIG. 12 depicts only the rendering of paragraph elements that contain only text, citation elements, or a combination of the two. It will be appreciated, however, that other types of elements may be present in an XML source document in connection with an embodiment of the invention, and elements of such other types may be processed, e.g., by means well-known in the relevant arts.)

In an embodiment of the invention, if it is detected in block 500 that a citation element is to be processed, the id code 456 (FIG. 11) is used in block 504 (FIG. 12) to identify the cited document and then to retrieve, e.g., metadata associated with that document from one or more databases. The retrieved information may then in an embodiment of the invention include the composite status of the document or, in an alternative embodiment of the invention, be used to retrieve the composite status.

Rendering the citation, according to the depicted embodiment of the invention, begins in block 506 with the insertion, e.g., of an HTML anchor tag (“<a>”) into the HTML output. The tag may include, e.g., a reference derived from the metadata retrieved in block 504 that is used to provide a hyperlink to the cited document and/or information associated with it. Based on the composite status, an image tag, referring to the appropriate citation status indicator, may then be inserted into the HTML output in block 508. The image tag may then be followed by the text of the citation, inserted in block 510, and then by an HTML closing anchor tag (“</a>”), inserted in block 512.

Processing the paragraph element 442 (FIG. 11) continues until it is determined in block 498 (FIG. 12) that the element has been processed fully. Processing then moves to the next paragraph element, until it is determined in block 494 that all elements have been processed. Once all elements have been processed, in an embodiment of the invention, the HTML output document may be completed in block 514, e.g., by providing to the output the appropriate HTML tags. If the output document has been created, e.g., in a memory buffer, then it may be output via a network in block 516.

Rendering as described above in connection with FIG. 12 may be done, e.g., in any of a number of well-known ways. For example, the XML source document may be processed, e.g., by an event-driven XML parser, such as SAX, with output elements being produced in response to parser events, or by a DOM parser, with HTML output being produced during traversal of the DOM tree. One or more additional transformations or kinds of may take place before, during, and/or after rendering 480. The transformation as described above may take place in two or more stages, with stages producing, e.g., one or more intermediate HTML, XML, or other documents, any or all of which may undergo further processing to produce output text of the opinion.

We claim:

1. A display of a citing document that comprises text and one or more citations, each citation referring to a cited document, the display comprising:
the text, the display of which comprises textual representations of the citations; and
one or more status indicators, each indicator visually associated with one textual representation of a citation and indicating the value of the cited document referred to by the respective associated citation.

2. The display of claim 1, wherein each status indicator is an icon.

3. The display of claim 2, wherein each icon is embedded in the displayed text immediately preceding the citation that is associated with the icon.

4. The display of claim 2, wherein each icon is a hyperlink to an entry in a citation index for the cited document that is associated with the citation that is associated with the icon.

5. The display of claim 1, wherein the citing document and one or more of the cited documents are judicial opinions.

6. The display of claim 5, wherein the value of the cited document is determined by estimating the precedential value of the cited document.

7. The display of claim 6, wherein the precedential value has been determined algorithmically based on entries in a citation index that refers to the cited document.

8. The display of claim 5, wherein the value of the cited document is determined by characterizing the treatment in the citing document of the cited document.

9. A method of presenting a display of a citing document that comprises text and one or more citations, each citation referring to a cited document, the method comprising: causing a display upon an electronic display device of the text of the citing document, the display comprising textual representations of the citations and further comprising one or more status indicators, each indicator visually associated with one textual representation of a citation and indicating the value of the cited document referred to by the respective associated citation.

10. The method of claim 9, wherein each status indicator is an icon.

11. The method of claim 10, wherein each icon is embedded in the displayed text immediately preceding the citation that is associated with the icon.

12. The method of claim 10, wherein each icon is a hyperlink to an entry in a citation index for the cited document that is associated with the citation that is associated with the icon.

13. The method of claim 9, wherein the citing document and one or more of the cited documents are judicial opinions.

14. The method of claim 13, comprising:
creating an estimate of the precedential value of the cited document; and
setting the value of cited document to the estimate.

15. The method of claim 14, wherein the estimate of the precedential value is determined algorithmically based on entries in a citation index that refers to the cited document.

16. The method of claim 13, comprising:
creating a characterization of the treatment in the citing document of the cited document; and
setting the value of the cited document to the characterization.

17. The method of claim 9, comprising:
rendering the document in HTML; and
transmitting the rendered document to a user agent.

18. The method of claim 17, wherein transmitting the rendered document to a user agent comprises transmitting the rendered document via a data network.

19. A system for presenting a display of a citing document that comprises text and one or more citations, each citation referring to a cited document, the system comprising:
a programmable processor, an input device that provides input to the system, a database, and a memory;
the memory storing instructions that, when executed by the processor, cause the system to carry out a method that comprises
causing a display upon an electronic display device of the text of the citing document, the display comprising textual representations of the citations and further comprising one or more status indicators, each indicator visually associated with one textual representation of a citation and indicating the value of the cited document referred to by the respective associated citation.

20. The system of claim 19, wherein each status indicator is an icon.

21. The system of claim 20, wherein each icon is embedded in the displayed text immediately preceding the citation that is associated with the icon.

22. The system of claim 20, wherein each icon is a hyperlink to an entry in a citation index for the cited document that is associated with the citation that is associated with the icon.

23. The system of claim 19, wherein the citing document and one or more of the cited documents are judicial opinions.

24. The system of claim 23, comprising:
creating an estimate of the precedential value of the cited document; and
setting the value of cited document to the estimate.

25. The system of claim 24, wherein the estimate of the precedential value is determined algorithmically based on entries in a citation index that refers to the cited document.

26. The system of claim 23, comprising:
creating a characterization of the treatment in the citing document of the cited document; and
setting the value of the cited document to the characterization.

27. The system of claim 19, comprising:
rendering the document in HTML; and
transmitting the rendered document to a user agent.

28. The system of claim 27, wherein transmitting the rendered document to a user agent comprises transmitting the rendered document via a data network.
